(19) United States
(12) Patent Application Publication
(10) Pub. No.: US 2007/0023094 A1
(43) Pub. Date: Feb. 1, 2007

(54) Faucet

(76) Inventor: Wu Chen Young, Dounan Township (TW)

Correspondence Address: TROXELL LAW OFFICE PLLC;SUITE 1404, 5205 LEESBURG PIKE, FALLS CHURCH, VA, 22041, US

(21) Appl. No.: 11/192,089

(22) Filed: Jul. 29, 2005

(51) Int. Cl. F16K 21/00

(52) U.S. Cl. 137/801

(57) ABSTRACT

A faucet includes an outlet pipe and a switch member. The switch member is fitted on the outlet pipe near a water outlet and provided thereon with a pull handle able to be pushed to turn around. The push handle can be pushed to turn on or turn off the switch member on the faucet and can also be washed clean by water flowing down out of the outlet pipe, able to prevent bacteria from spreading and having great practicability.

### BACKGROUND OF THE INVENTION

1. Field of the Invention

This invention relates to a faucet, particularly to one simple in structure, able to prevent bacteria from spreading and having high applicability and practicability.

2. Description of the Prior Art

A conventional device for combining a connecting pipe with a faucet, as shown in FIGS. 1 and 2, includes a faucet 10, a connecting sleeve 20 and a connecting pipe 30 combined together.

The faucet 10 has an outer wall 11 of its water outlet formed with male threads 12 to be threadably combined with the connecting sleeve 20 that has its lower end fitted with the connecting pipe 30.

The connecting sleeve 20 has its upper opening formed with female threads 21 and the inner wall of its lower opening formed with an annular fitting recess 22.

The connecting pipe 30 is a bent pipe having the outer wall of its lower opening 31 formed with an outer flange 32 to be combined with the annular fitting recess 22 of the connecting sleeve 20.

The connecting pipe 30 can be combined with the faucet 10 by the connecting sleeve 20 that has the female threads 21 at the upper end screwed with the male threads 12 on the outer wall 11 of the water outlet of the faucet 10 and has its annular fitting recess 22 fitted with the outer flange 32 of the connecting pipe 30.

However, the foresaid conventional device is complicated in structure and has low practicability. As mentioned above, only by the connecting sleeve 20 that has its upper opening formed with female threads 21 and its lower opening formed with a fitting recess 22, can the connecting pipe 30 be combined together with the faucet 10. In addition, the connecting pipe 30 is structured improperly; therefore, when washed, a person's hands are likely to be bump against the connecting pipe 30 and get injured, and the space for washing hands is also confined by the connecting pipe 30, resulting in much inconvenience in use. Moreover, when water pressure is low, water can hardly be guided to flow out through the bent connecting pipe 30, having less practicability and applicability.

Another conventional device for flushing a faucet automatically, as shown in FIGS. 3 and 4, includes a faucet 1, an adapter 2, a connector 3, a water-saving member 4, a switch valve 5 and a flushing pipe 6 combined together.

The adapter 2 has one side of its upper end cut open and extending outward to form two parallel fixing ears 21. Thus, after the faucet 1 has its water outlet end inserted in the upper end of the adapter 2, the adapter 2 can be firmly secured around the water outlet end of the faucet 1 by a bolt 22 screwed through the two fixing ears 21 and locked closely by a nut 23. Further, the adapter 2 has its lower end formed with a threaded portion 24 to be threadably combined with the connecting pipe 3 that has its lower end connected with the water-saving member 4, with a washer 41 fitted between the connector 3 and the water-saving member 4. The connecting pipe 3 has one sidewall bored with a threaded hole 31 communicating with the interior. The switch valve 5 is horizontally fitted in the threaded hole 31 of the connector 3 and has its outer end connected by a nut 61 with the flushing pipe 6 extending upward and then bent downward to have its water outlet facing the faucet 1.

In operating, when the switch valve 5 is turned on, water will flow through the faucet 1 and the adapter 2 as well as the connector 3 and then flow to the flushing pipe 6 through the switch valve 5 to spray on the upper side of the faucet 1 for cleaning the turning handle of the faucet 1. However, when carrying out flushing on the upper side of the faucet 1, water flowing out of the flushing pipe 6 may splash about and wet a large area nearby, and after flushing, filthy water will flow onto the connector 3 as well as the water-saving tube 4 to pollute them and proliferate bacteria thereon and also may remain on articles or hands being cleaned.

To sum up, the above-mentioned two conventional devices have the following defects.

1. The device is composed of lots of components, complicated in assembly.

2. There are too many components, complicating procedures and increasing cost in manufacturing.

3. The faucet is flushed from above; therefore, after washing, filthy water will flow onto articles and hands being cleaned.

4. The faucet has its upper side flushed directly, rendering the turning handle of the faucet easy to rust and become deadlocked.

### SUMMARY OF THE INVENTION

The objective of the invention is to offer a faucet simple in structure, able to prevent bacteria from spreading and having high applicability and practicability.

The faucet in the present invention includes an outlet pipe and a switch member combined together.

The outlet pipe is a hollow pipe having one end connected with a water source and the other end formed with a water outlet.

The switch member is fitted on the outlet pipe near the water outlet and provided thereon with a push member able to be pushed to turn. The push member can be pushed to turn on or turn off the switch member on the faucet.

By so designing, the push member not only can be pulled to turn on or turn off the switch member on the faucet, but also can be washed clean by water flowing out of the outlet pipe, able to prevent bacteria from spreading and having great practicability.

### BRIEF DESCRIPTION OF DRAWINGS

This invention will be better understood by referring to the accompanying drawings, wherein:

FIG. 1 is an exploded perspective view of the structure of a conventional faucet-connecting pipe;

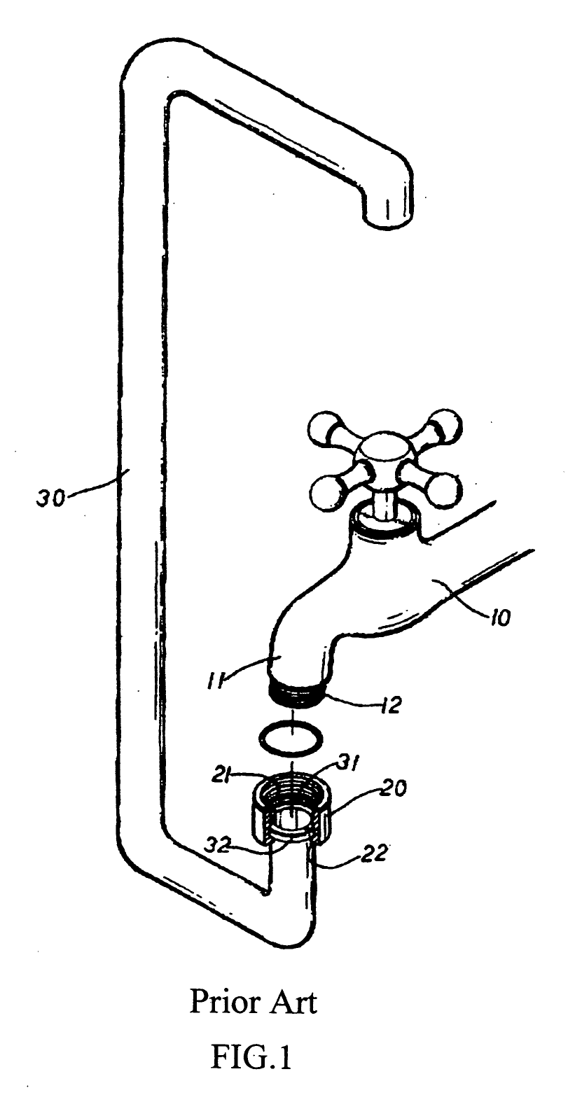

FIG. 2 is a perspective view of the structure of the conventional faucet-connecting pipe in a using condition;

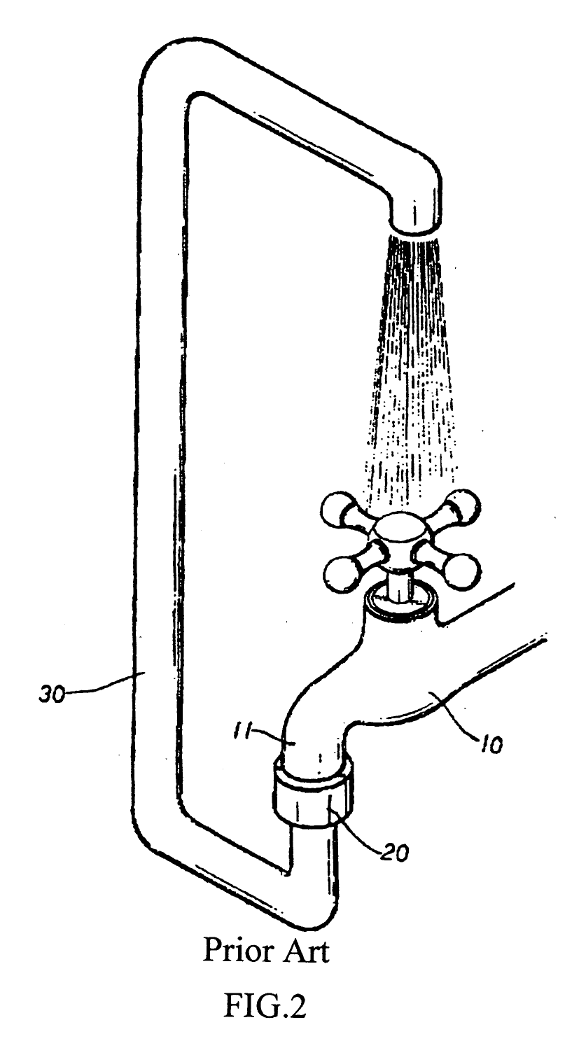

FIG. 3 is an exploded perspective view of a conventional device for flushing a faucet automatically;

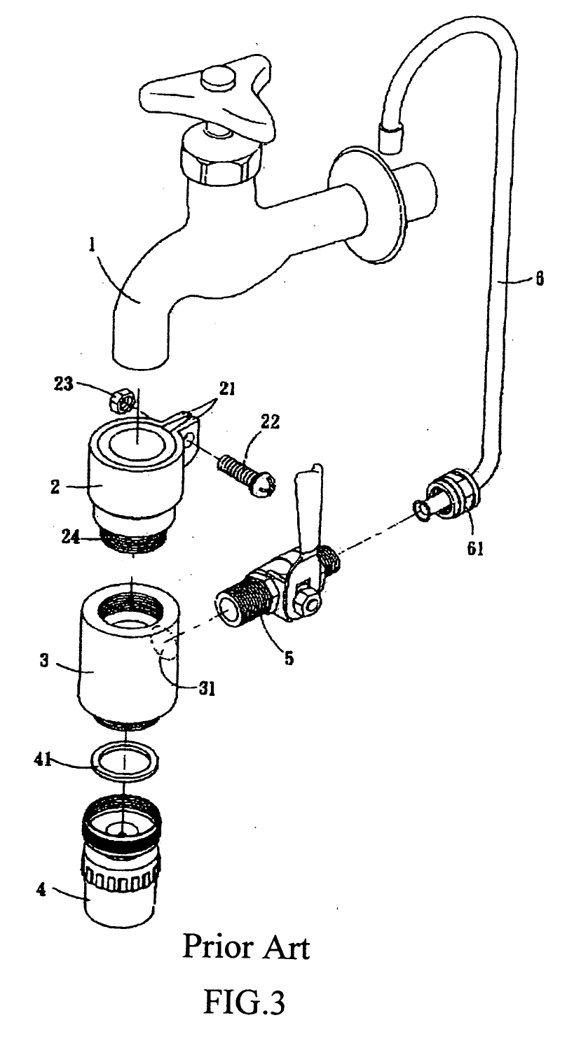

FIG. 4 is a side cross-sectional view of the conventional device for flushing a faucet automatically in a using condition;

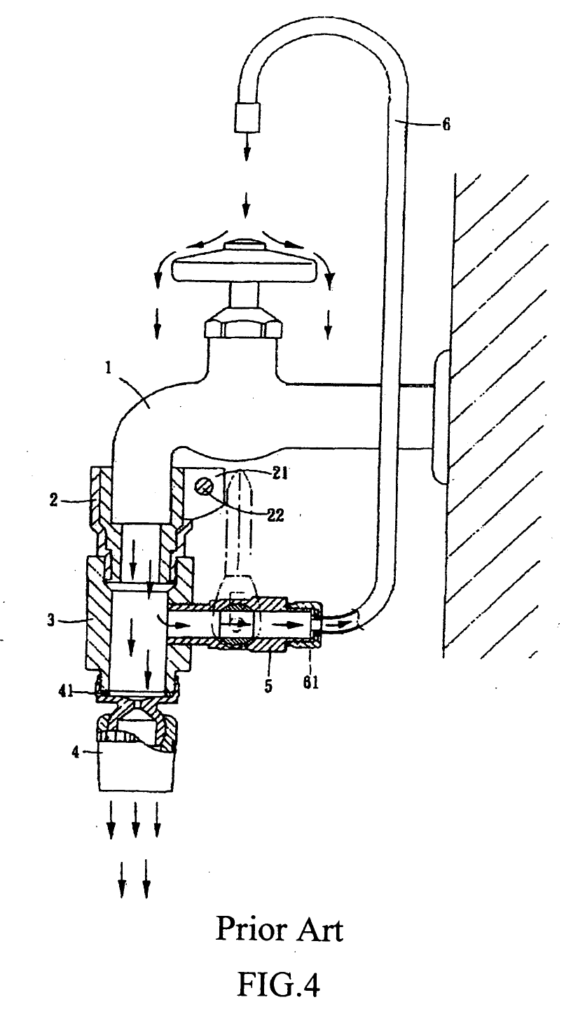

FIG. 5 is a perspective view of a first preferred embodiment of a faucet in the present invention;

FIG. 6 is a perspective view of the first preferred embodiment of the faucet in an operating condition in the present invention;

FIG. 7 is a perspective view of a second preferred embodiment of a faucet in a using condition in the present invention; and

FIG. 8 is a front view of a third preferred embodiment of a faucet in a using condition in the present invention.

### DETAILED DESCRIPTION OF THE PREFERRED EMBODIMENT

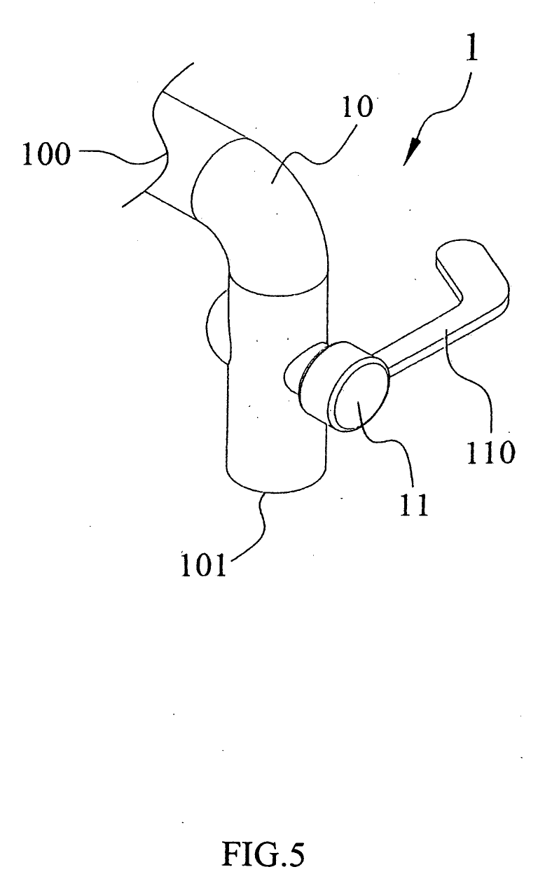

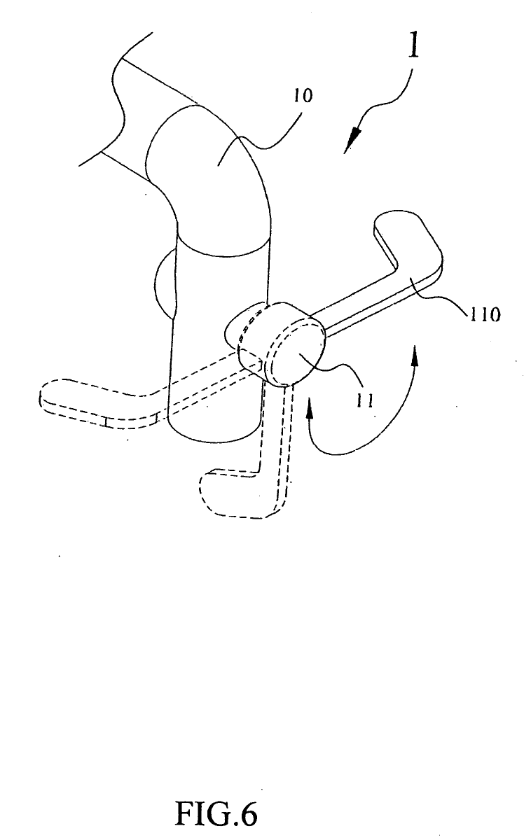

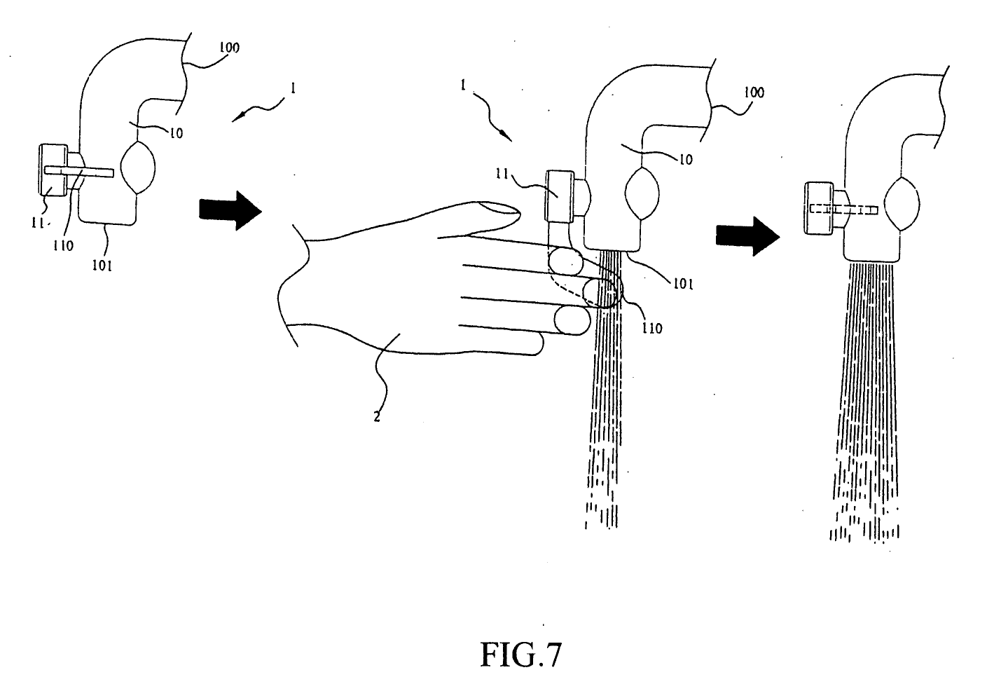

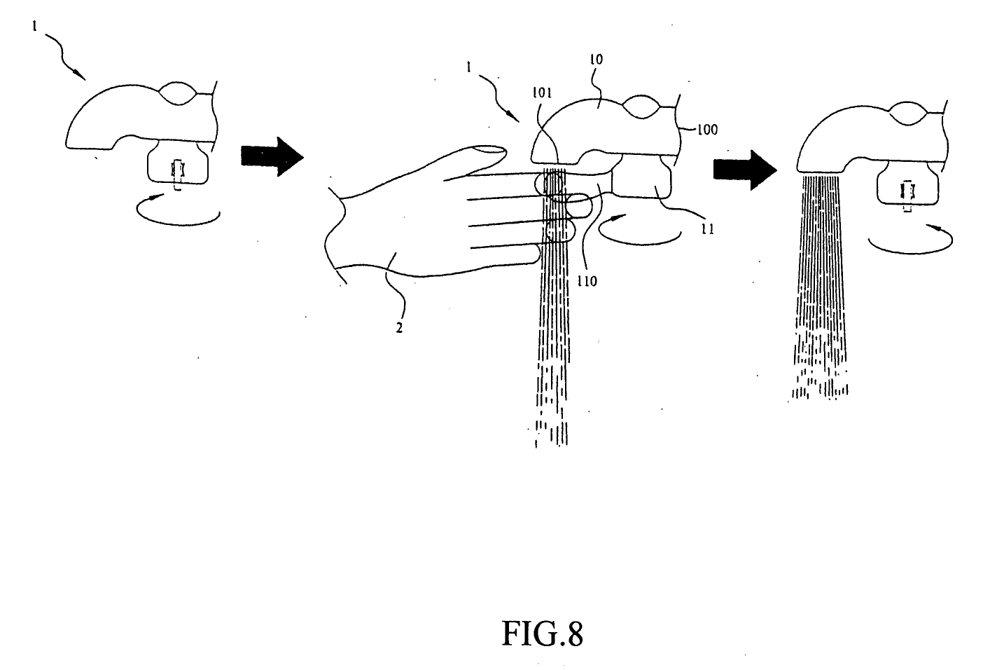

A first, a second and a third preferred embodiment of a faucet in the present invention, as shown in FIGS. 5 to 8, includes an outlet pipe 10 and a switch member 11 made of plastic or metal.

The outlet pipe 10 is a hollow pipe having one end connected with a water source 100 and the other end formed with a water outlet 101 for water to flow out therethrough.

The switch member 11 is fitted on the outlet pipe 10 near the water outlet 101 and has a push handle 110 provided thereon. The switch member 11 can be axially positioned vertically or horizontally to the water outlet 101 of the outlet pipe 10. The push handle 110 of the switch member 11 can be pushed to turn on or off the switch member 11 on the faucet.

The push handle 110 of the switch member 11, connected with the outlet pipe 10 through the switch member 11 and having the switch member 11 serving as a pivot, can be pushed to turn by a hand 2 for different angles to control the amount of water flowing out of the water outlet 101 through the outlet pipe 10. To turn the faucet on, only push to turn the push handle 110 of the switch member 11 for a certain angle. To turn the faucet off, the push handle 110 is first turned reversely to be positioned under the flowing water and flushed down from above so as to clean the push handle 110 and prevent bacteria and filth from remaining on the push handle 110, and then the push handle 110 is continuously turned reversely until the faucet is completely turned off.

As can be understood from the above description, this invention has the following advantages.

1. The structure of each component is quite simple.

2. There are only a few components so cost in manufacturing is quite low.

3. The push handle is flushed by water flowing down from above; therefore, after the push handle is cleaned, filthy water will not remain on the push handle, avoiding proliferation of bacteria.

4. Water flowing down from above directly flushes the push handle, impossible to wet the switch member and able to prevent the switch member from rusting and becoming deadlocked.

While the preferred embodiments of the invention have been described above, it will be recognized and understood that various modifications may be made therein and the appended claims are intended to cover all such modifications that may fall within the spirit and scope of the invention.

I claim:

1. A faucet comprising:
An outlet pipe having a hollow interior, said outlet pipe having one end connected with a water source, said outlet pipe having the other end formed with a water outlet: and
A switch member fitted on said outlet pipe near said water outlet, said switch member provided thereon with a push handle able to be pushed to turn around, said push handle able to be pushed to turn on or turn off said switch member on a faucet.

2. The faucet as claimed in claim 1, wherein said switch member is axially positioned vertically to said water outlet of said outlet pipe.

3. The faucet as claimed in claim 1, wherein said switch member is axially positioned horizontally to said water outlet of said outlet pipe.

4. The faucet as claimed in claim 1, wherein said outlet pipe and said switch member are made of plastic.

5. The faucet as claimed in claim 1, wherein said outlet pipe and said switch member are made of metal.
